(19) United States
(12) Patent Application Publication
(10) Pub. No.: US 2023/0366539 A1
(43) Pub. Date: Nov. 16, 2023

(54) Air Intake Apparatus

(71) Applicant: XueFeng HUANG, Changzhou City Jiangsu Province (CN)

(72) Inventor: XueFeng HUANG, Changzhou City Jiangsu Province (CN)

(73) Assignee: Well Traveled Inports, Inc., Amelia Island, FL (US)

(21) Appl. No.: 18/134,502

(22) Filed: Apr. 13, 2023

(30) Foreign Application Priority Data
Apr. 13, 2022 (CN) 202220863425.5

(51) Int. Cl. F23D 14/24; F23D 14/70

(52) U.S. Cl. CPC F23D 14/24; F23D 14/70

(57) ABSTRACT

The present utility model relates to the technical field of burners, and specifically relates to a spiral air supplement mechanism and a gas heater having the air supplement mechanism. A spiral air supplement mechanism is characterized by comprising a guide cylinder, wherein an outer surface of the guide cylinder is provided with an air supplement support plate; an outer side of the outer cover mounting plate is sleeved with an air guide hood; air supplement ports are uniformly provided on the outer cover mounting plate; a surface of the guide cylinder is provided with a plurality of spiral guide assemblies; a lower end of the spiral guide assembly communicates with the air supplement port; an upper end extends to an end of the guide cylinder; and the spiral guide assemblies are used for forming an air flow entering from the air supplement port into a spiral air flow. The utility model solves the problem of insufficient combustion. The guide cylinder and the air guide hood form an air supplementing passage, and the external air enters the guide cylinder and the air guide hood through the spiral guide assembly, increasing the contact between the flame and the air, so that the flame is fully combusted. Also, the spiral airflow further increases the combustion height of the flame.

### FIELD OF INVENTION

The present utility model relates to the technical field of burners, and specifically relates to a spiral air supplement mechanism and a gas heater having the air supplement mechanism.

### BACKGROUND OF THE INVENTION

Burner is a general term for a device that injects fuel and air in a certain manner for mixing and burning. The burner has various classification modes according to its different attributes. According to fuel mode, it is divided into a fuel oil burner, a gas burner, a light oil burner and a dual fuel burner. The gas burner is divided into a natural gas burner and a city gas burner.

In the conventional gas heater, the combustion environment at the bottom of the air guide hood is better when the air is introduced into the bottom of the air guide hood, while the combustion environment at the upper part of the air guide hood is not enough, which will cause the problem of insufficient fuel and waste of energy. Meanwhile, time insufficient combustion will easily cause the generation of pollutants. In addition, as the air is introduced into the bottom of the air guide hood, it is inconvenient to adjust the shape of the flame, and the height of combustion is poor.

### OBJECT OF THE INVENTION

In view of the deficiencies of the prior art, the present utility model designs a spiral air supplement mechanism, which can provide air required for combustion in the middle and upper part of an air guide hood and improve the combustion environment in the middle and upper part of the air guide hood, so that the combustion is more sufficient. Meanwhile, the air flow entering the air guide hood from the spiral air supplement mechanism has a certain speed and rotation capacity, which can make the height of the flame in the air guide hood better, and drive the flame to rotate, so as to improve the ornamental value of the combustion flame.

The technical solution of the utility model is as follows.

A spiral air supplement mechanism is characterized by comprising a guide cylinder, wherein an outer surface of the guide cylinder is provided with an air supplement support plate; an outer side of the guide cylinder is sleeved with an air guide hood; air supplement ports are uniformly provided on the air supplement support plate; a surface of the guide cylinder is provided with a plurality of spiral guide assemblies; a lower end of the spiral guide assembly communicates with the air supplement port; an upper end extends to an end of the guide cylinder; and the spiral guide assemblies are used for forming an air flow entering from the air supplement port into a spiral air flow.

Furthermore, the spiral guide assembly comprises a set of guide plates arranged in parallel and spirally on the outer surface of the guide cylinder; the ends of the guide plates are closely adhered to the inner wall of the air guide hood; and the two guide plates, the outer wall of the guide cylinder and the inner wall of the air guide hood form a spiral guide passage for the flow of air.

Furthermore, the spiral guide assembly comprises a set of guide plates arranged in parallel and spirally on the outer surface of the guide cylinder, and further comprises an outer guide cylinder, wherein the outer guide cylinder is covered on the outer side of the guide plate and the lower end thereof is connected to the air supplement support plate; the end of the guide plate is closely adhered to the inner wall of the outer guide cylinder; the air guide hood is covered on the outer guide cylinder; and two guide plates, the outer wall of the guide cylinder and the inner wall of the outer guide cylinder form a spiral guide passage for the flow of air.

Further, the spiral guide assembly comprises a set of guide plates arranged in parallel and spirally on the outer surface of the guide cylinder, and a sealing cover plate connected to the ends of the guide plates, wherein the two guide plates, the sealing cover plate and the outer wall of the guide cylinder form a spiral guide passage for air flow.

A gas heater comprises a furnace end and a heater housing arranged in sequence, wherein the heater housing is provided with a furnace end mounting hole, and the furnace end is mounted in the furnace end mounting hole and fixedly connected to the heater housing, characterized by further comprising the spiral air supplement mechanism described above, wherein the spiral air supplement mechanism is provided on the heater housing.

Further, it further comprises an air inlet casing, wherein the air inlet casing is covered on the outside of the spiral air supplement mechanism and the lower end thereof is connected to the heater housing.

Further, air inlets are uniformly provided on the outer surface of the air inlet casing.

Further, a support member is also included for supporting the air inlet casing, so that a ventilation gap exists between the lower end of the air inlet casing and the heater housing.

Further, a furnace end fixing plate is fixed to a lower end of the bottom plate, and the furnace end is located inside the furnace end fixing plate.

In summary, the utility model has the following beneficial effects.

The present utility model designs a spiral air supplement mechanism. Air enters from an air supplement port of an air supplement support plate, and is then supplemented into an air guide hood via a spiral guide assembly, so as to improve the combustion environment in the middle part and the upper part of the air guide hood, and the combustion in the air guide hood is more sufficient. Furthermore, the air flow entering from the spiral guide assembly has a spiral rising trend, thereby driving the flame in the air guide hood to spiral up, changing the shape of flame combustion, and improving the ornamental value of the flame. It also increases the combustion height of the flame.

### BRIEF DESCRIPTION OF THE DRAWINGS

The accompanying drawings, which are included to provide a further understanding of the utility model and constitute a part of this specification, illustrate the utility model together with embodiments of the utility model and do not limit the utility model. In the drawings,

FIG. 1 is a schematic perspective view of Embodiment I of a spiral air supplement mechanism;

FIG. 2 is a schematic perspective view of Embodiment 1 of a spiral air supplement mechanism, with an air guide hood removed;

FIG. 3 is a schematic perspective view of Embodiment II of a spiral air supplement mechanism;

FIG. 4 is a schematic perspective view of Embodiment III of a spiral air supplement mechanism;

FIG. 5 is a top view of Embodiment III of a spiral air supplement mechanism;

FIG. 6 is a schematic perspective view of a gas heater;

FIG. 7 is a schematic front view of a gas heater;

FIG. 8 is a schematic cross-sectional view of FIG. 7;

FIG. 9 is a schematic perspective view of a heater having a ventilation gap between an air inlet casing and a heater housing;

In the drawings, 1—guide cylinder, 2—air supplement support plate, 20—air supplement port; 3—air guide hood, 4—spiral guide assembly, 40—guide plate, 41—outer guide cylinder, 42—sealing cover plate, 5—furnace end, 6—heater housing, 60—furnace end mounting hole, 61—furnace end fixing plate, 7—spiral air supplement mechanism, 8—air inlet casing, 80—air inlet, 9—support member, and 90—ventilation gap.

### DETAILED DESCRIPTION OF THE INVENTION

The technical solutions in the embodiments of the utility model will be described clearly and completely in conjunction with the accompanying drawings in the embodiments of the utility model. Obviously, the described embodiments are only part of the embodiments of the utility model, rather than all of the embodiments. Based on the embodiments in the utility model, all other embodiments obtained by a person skilled in the art without involving any inventive effort are within the scope of protection of the utility model.

### Embodiment I of Spiral Air Supplement Mechanism

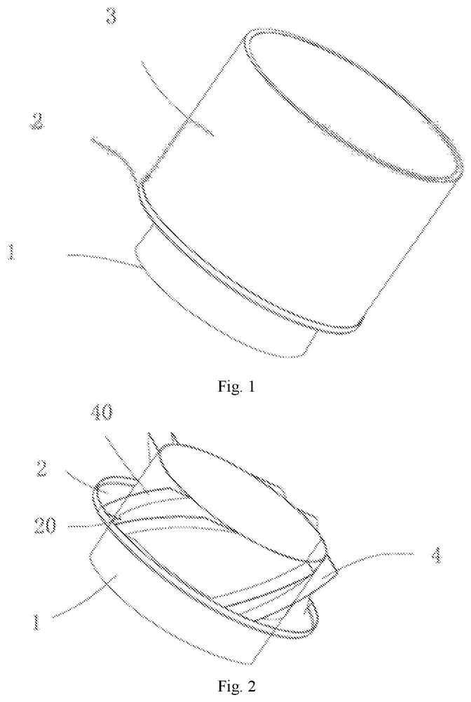

As shown in FIGS. 1 and 2, a spiral air supplement mechanism is characterized by comprising a guide cylinder 1. An outer surface of the guide cylinder 1 is provided with an air supplement support plate 2. An outer side of the guide cylinder 1 is sleeved with an air guide hood 3. Air supplement ports 20 are uniformly provided on the air supplement support plate 2. A surface of the guide cylinder 1 is provided with a plurality of spiral guide assemblies 4. A lower end of the spiral guide assembly 4 communicates with the air supplement port. An upper end extends to an end of the guide cylinder. The spiral guide assemblies 4 are used for forming an air flow entering from the air supplement port into a spiral air flow.

The present utility model designs a spiral air supplement mechanism, which can introduce air into the air guide hood, improve the combustion environment in the middle and upper parts of the air guide hood, make the combustion more sufficient, and improve the combustion efficiency. Furthermore, the air flow entering from the spiral guide assembly has a spiral rising trend, thereby driving the flame in the air guide hood to spiral up, changing the shape of flame combustion, and improving the ornamental value of the flame. It also increases the combustion height of the flame.

The spiral guide assembly 4 in the present embodiment includes a set of guide plates 40 arranged in parallel and spirally on the outer surface of the guide cylinder 1. The ends of the guide plates 40 are closely adhered to the inner wall of the air guide hood 3. Two guide plates, the outer wall of the guide cylinder and the inner wall of the air guide hood form a spiral guide passage for the flow of air. In the present embodiment, the inner wall of the air guide hood must be adhered to the ends of the guide plates so as to ensure the leak-proof-ness of the spiral guide passage, and the air passing there through can obtain a better speed and direction.

### Embodiment II of Spiral Air Supplement Mechanism

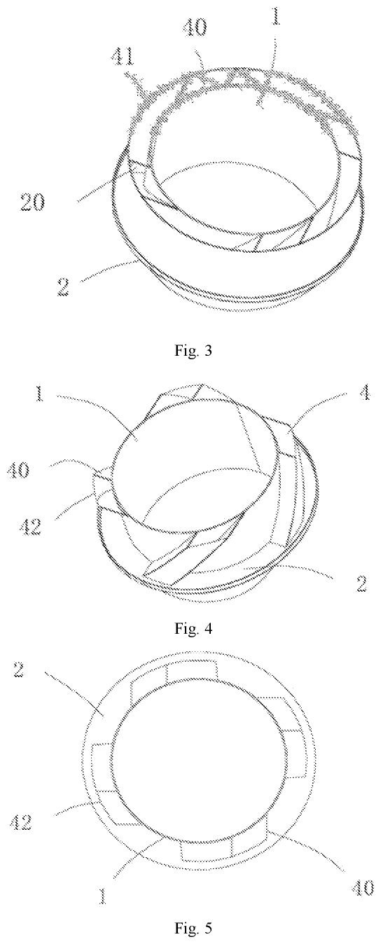

The other structures in the present embodiment are the same as the structure of Embodiment I of the spiral air supplement mechanism, and the difference lies in that the structure of the spiral guide assembly is different. With reference to FIG. 3, the spiral guide assembly 4 in the present embodiment includes a set of guide plates 40 arranged in parallel and spirally on the outer surface of the guide cylinder 1, and further includes an outer guide cylinder 41. The outer guide cylinder 41 is covered on the outer side of the guide plate and the lower end thereof is connected to the air supplement support plate 2. The end of the guide plate is closely adhered to the inner wall of the outer guide cylinder. The air guide hood 3 is covered on the outer guide cylinder 41. Two guide plates, the outer wall of the guide cylinder and the inner wall of the outer guide cylinder form a spiral guide passage for the flow of air. At this time, the diameter of the air guide hood is not required to match with the diameter of the outer guide cylinder, reducing the need for the machining accuracy of the air guide hood, and facilitating the assembly of the air guide hood.

### Embodiment III of Spiral Air Supplement Mechanism

The other structures in the present embodiment are the same as the structure of Embodiment I of the spiral air supplement mechanism, and the difference lies in that the structure of the spiral guide assembly is different. With reference to FIGS. 4 and 5, the spiral guide assembly 4 in the present embodiment includes a set of guide plates 40 arranged in parallel and spirally on the outer surface of the guide cylinder, and further includes a sealing cover plate 42 connected to the end of the guide plates. Two guide plates, a sealing cover plate and an outer wall of the guide cylinder form a spiral guide passage for the flow of air. The sealing cover plate can be connected to the guide plates by means of welding, and can also be integrally formed with the guide plates by means of bending and forming. Since the guide plate, the sealing cover plate and the guide cylinder form a sealed spiral guide passage, the diameter of the air guide hood at this time does not need to be fitted with the outer end of the guide plate, reducing the need for machining accuracy of the air guide hood, and facilitating the assembly of the air guide hood.

### Gas Heater Embodiment

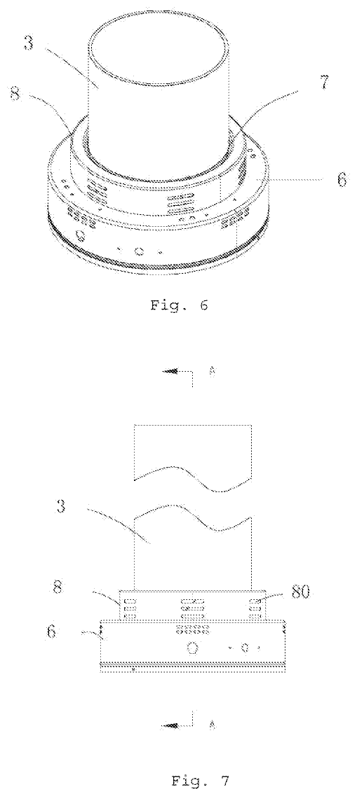

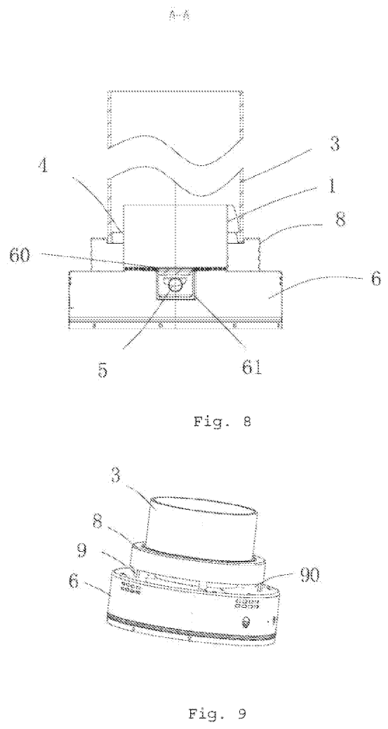

With reference to FIGS. 6 to 8, a gas heater includes a furnace end 5 and a heater housing 6 successively arranged. The heater housing 6 is provided with a furnace end mounting hole 60, and the furnace end 5 is mounted in the furnace end mounting hole and is fixedly connected to the heater housing 6. It is characterized by further including the above-mentioned spiral air supplement mechanism 7. The spiral air supplement mechanism 7 is arranged on the heater housing 6.

It further includes an air inlet casing 8. The intake cover piece 8 is positioned outside the spiral air supplement mechanism and the lower end thereof is connected to the heater housing 6. The intake cover piece is used to surround the outside of the spiral air supplement mechanism to improve the overall aesthetics of the device.

Further, air inlets 80 are uniformly provided on the outer surface of the air inlet casing 8.

With reference to FIG. 9, it further includes a support member for supporting the air inlet casing so that a ventilation gap is provided between the lower end of the air inlet casing and the heater housing. Here, the connection relationship between the air inlet casing and the heater housing is formed by providing a support member. On the one hand, the air inlet casing is effectively supported, and on the other hand, the ventilation gap formed can better ensure the inflow of air. The support member is a plurality of support sheets fixedly connected to the heater housing, and one side of the upper surface of the support sheet forms a sunken bearing surface. The end of the air inlet casing is connected to the bearing surface, or a plurality of support legs are welded or directly pressed and formed at the lower end of the protective cover. The lower ends of the support legs are connected to the housing.

Further, a furnace end fixing plate 61 is fixed to a lower end of the heater housing 6. The furnace end 5 is located inside the furnace end fixing plate which is a U-shaped plate. The furnace end is arranged in the U-shaped plate. Two ends of the U-shaped plate extend to form a horizontal plate connected to the heater housing, and the horizontal plate is connected to the heater housing via a fastener.

The air guide hood described in the present application is a transparent pipe. A user can observe the shape of a flame inside the air guide hood. The air guide hood is preferably made of glass.

In summary, the utility model has the following beneficial effects.

1. The present utility model designs a spiral air supplement mechanism. Air enters from an air supplement port of an air supplement support plate, and is then supplemented into an air guide hood via a spiral guide assembly, so as to improve the combustion environment in the middle part and the upper part of the air guide hood, and the combustion in the air guide hood is more sufficient. Furthermore, the air flow entering from the spiral guide assembly has a spiral rising trend, thereby driving the flame in the air guide hood to spiral up, changing the shape of flame combustion, and improving the ornamental value of the flame. It also increases the combustion height of the flame.

Finally, it should be noted that the above described is only preferred embodiments of the utility model, and is not intended to limit the utility model. Although the detailed description of the utility model is given with reference to the preceding embodiments, those skilled in the art may still modify the technical solutions described in the preceding embodiments or replace some of the technical features with equivalent ones. Any modifications, equivalents, improvements, etc. within the spirit and principles of this utility model are intended to be included within the scope of this utility model.

1. A spiral air supplement mechanism, characterized by comprising a guide cylinder, wherein an outer surface of the guide cylinder is provided with an air supplement support plate; an outer side of the guide cylinder is sleeved with an air guide hood; air supplement ports are uniformly provided on the air supplement support plate; a surface of the guide cylinder is provided with a plurality of spiral guide assemblies; a lower end of the spiral guide assembly communicates with the air supplement port; an upper end extends to an end of the guide cylinder; and the spiral guide assemblies are used for forming an air flow entering from the air supplement port into a spiral air flow.

2. The spiral air supplement mechanism according to claim 1, characterized in that the spiral guide assembly comprises a set of guide plates arranged in parallel and spirally on the outer surface of the guide cylinder; the ends of the guide plates are closely adhered to the inner wall of the air guide hood; and the two guide plates, the outer wall of the guide cylinder and the inner wall of the air guide hood form a spiral guide passage for the flow of air.

3. The spiral air supplement mechanism according to claim 1, characterized in that the spiral guide assembly comprises a set of guide plates arranged in parallel and spirally on the outer surface of the guide cylinder, and further comprises an outer guide cylinder, wherein the outer guide cylinder is covered on the outer side of the guide plate and the lower end thereof is connected to the air supplement support plate; the end of the guide plate is closely adhered to the inner wall of the outer guide cylinder; the air guide hood is covered on the outer guide cylinder; and two guide plates, the outer wall of the guide cylinder and the inner wall of the outer guide cylinder form a spiral guide passage for the flow of air.

4. The spiral air supplement mechanism according to claim 1, characterized in that the spiral guide assembly comprises a set of guide plates arranged in parallel and spirally on the outer surface of the guide cylinder, and a sealing cover plate connected to the ends of the guide plates, wherein the two guide plates, the sealing cover plate and the outer wall of the guide cylinder form a spiral guide passage for the flow of air.

5. A gas heater comprising a furnace end and a heater housing arranged in sequence, wherein the heater housing is provided with a furnace end mounting hole, and the furnace end is mounted in the furnace end mounting hole and fixedly connected to the heater housing, characterized by further comprising the spiral air supplement mechanism according to any one of claims 1 to 4, wherein the spiral air supplement mechanism is provided on the heater housing.

6. The gas heater according to claim 5, characterized by further comprising an air inlet casing, wherein the air inlet casing is covered on the outside of the spiral air supplement mechanism and the lower end thereof is connected to the heater housing.

7. The gas heater according to claim 6, characterized in that air inlets are uniformly provided on the outer surface of the air inlet casing.

8. The gas heater according to claim 6, characterized in that a support member is also included for supporting the air inlet casing, so that a ventilation gap exists between the lower end of the air inlet casing and the heater housing.

9. The gas heater according to claim 5, characterized in that a furnace end fixing plate is fixed to a lower end of the heater housing, and the furnace end is located inside the furnace end fixing plate.
